(19) United States
(12) Patent Application Publication
(10) Pub. No.: US 2011/0218510 A1
(43) Pub. Date: Sep. 8, 2011

(54) VIAL HOLDER

(76) Inventor: Louis Bojrab, Northville, MI (US)

(21) Appl. No.: 12/715,539

(22) Filed: Mar. 2, 2010

(51) Int. Cl. A61J 1/16; A61J 1/14

(52) U.S. Cl. 604/411; 604/415

(57) ABSTRACT

A vial holder for a vial. The vial includes a body portion having a generally tubular portion interposed between a bottom and a neck portion. The neck portion interconnects the body portion to a head portion. A cap portion is connected to the head portion. The cap portion includes a membrane for retaining a fluid within the vial. The vial holder includes a first restraining portion for, at least in part, restraining the vial in a first direction, and an urging member for resisting a force exerted in a second direction on the vial when a needle is urged to pierce the membrane. The first direction is generally opposite the second direction.

### TECHNICAL FIELD

The disclosure relates generally to holders for vials, and specifically to holders that permit fluid to be removed from vials.

### BACKGROUND

In laboratory, pharmaceutical and healthcare environments, many analyses and experiments are conducted in controlled environments. Often, these environments include adding a precise volume of different fluids. When these fluids are from a vial and extracted from the vial with a syringe, a user may be required to use two hands to extract the fluid from the vial. In sterile environments, two users [one (unsterile) to hold the vial and another (sterile) to hold the syringe) may be required since a user in a sterile environment may desire to refrain from touching a vial that is unsterile. Often, multiple vials of differing sizes may be required to provide the desired fluids. Between procedures, the vials within the controlled environment may need to be changed. What is needed is a vial holder that can be easily changed to hold a variety of sizes of vials.

### SUMMARY

Exemplary vial holders are provided for holding an infinite number of sizes of vials adjacent a station where a user need only contact a syringe for extracting fluids from the vials.

### BRIEF DESCRIPTION OF THE DRAWINGS

The drawings are illustrative embodiments. The drawings are not necessarily to scale and certain features may be removed, exaggerated, moved, or partially sectioned for clearer illustration. The embodiments illustrated herein are not intended to limit or restrict the claims.

FIG. 1 is perspective view of a vial holder according to an embodiment.

FIG. 2 is a front view of the vial holder of FIG. 1.

FIG. 3 is a sectional view taken along line 3-3 of FIG. 2.

FIG. 4 is a front view of the vial holder of FIG. 1, illustrated with a first vial.

FIG. 5 is a front view of the vial holder of FIG. 1, illustrated with a second vial.

FIG. 6 is a view of an embodiment of an illustrative vial for use with at least a portion of the vial holders illustrated herein.

FIG. 7 is a perspective view of an embodiment a vial holder, illustrated in multiple configurations.

FIG. 8 is a sectional view taken along line 8-8 of FIG. 7

FIG. 9 is a perspective view of an embodiment a vial holder.

FIG. 10 is a view of the vial holder of FIG. 9, with a vial illustrated in phantom.

FIG. 11 is a front view of the vial holder of FIG. 10, illustrated with a first exemplary vial.

FIG. 12 is a side view of the vial holder taken along line 12-12 of FIG. 11.

FIG. 13 is a partial sectional view taken along line 13-13 of FIG. 12.

FIG. 14 is a front view of an embodiment a vial holder illustrated with a second exemplary vial.

FIG. 15 is a side view taken along line 15-15 of FIG. 14.

FIG. 16 is a partial sectional view taken along line 16-16 of FIG. 15.

FIG. 17 is a front view of the vial holder of FIG. 14 shown with a vial partially inserted therein.

FIG. 17A is a partial sectional view taken along line 17A-17A of FIG. 17.

FIG. 18 is a partial sectional view of an agitator for use with vial holders such as the vial holders disclosed herein, with an exemplary vial holder illustrated partially in phantom.

FIG. 19 is a partial sectional view taken along line 19-19 of FIG. 18.

FIG. 20 is a partial sectional view of another embodiment of an agitator for use with vial holders such as the vial holders disclosed herein.

### DETAILED DESCRIPTION

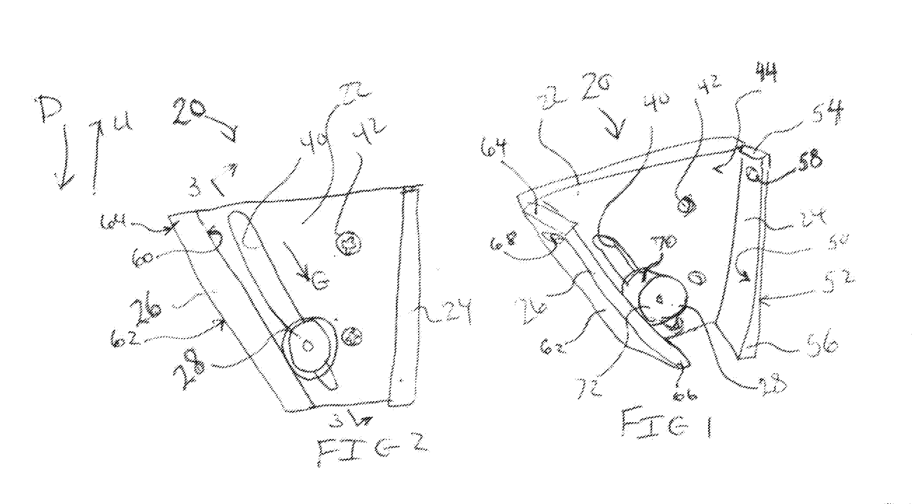

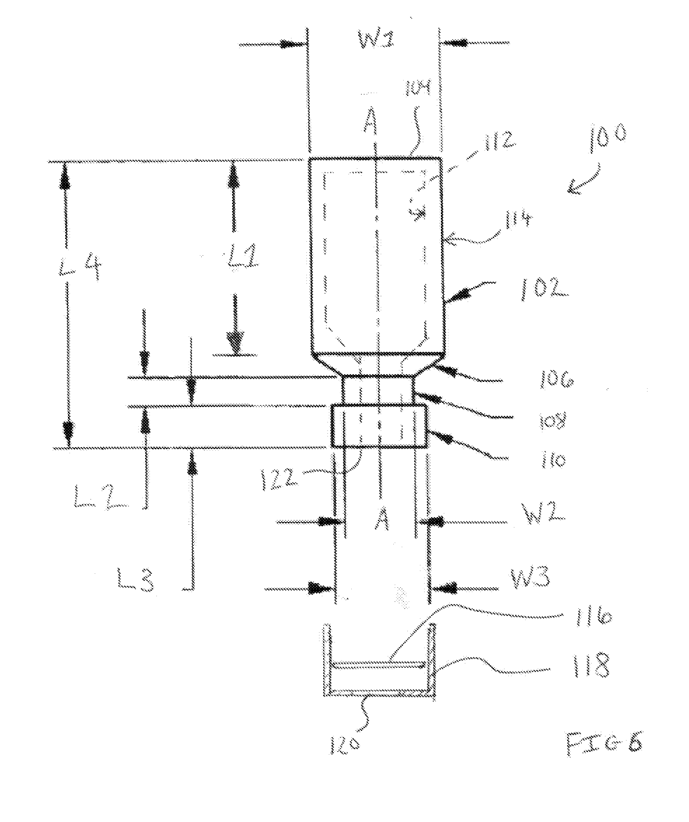

FIGS. 1-5 illustrate an embodiment of a vial holder 20. The vial holder 20 includes a back plate 22, a generally vertical side plate 24 a guide plate 26, a guide member 28, and an upper restraint 30 (FIGS. 4 and 5). The back plate 22 includes a slot 40, a plurality of attachment apertures 42, and a front surface 44. The side plate 24 is a generally planar structure including an inside surface 50, an outside surface 52, a top end 54, a bottom end 56, and a side aperture 58. The guide plate 26 includes an inside surface 60, an outside surface 62, a top end 64, a bottom end 66, and an aperture 68. The guide member 28 includes a generally cylindrical outer surface 70, a first surface 72, a second surface 74, a pin 76, and a retaining member 78. The retaining member 78 includes a front surface 80 (FIG, 3). The upper restraint 30 interconnects the side aperture 58 with the aperture 68 (FIGS. 4 and 5).

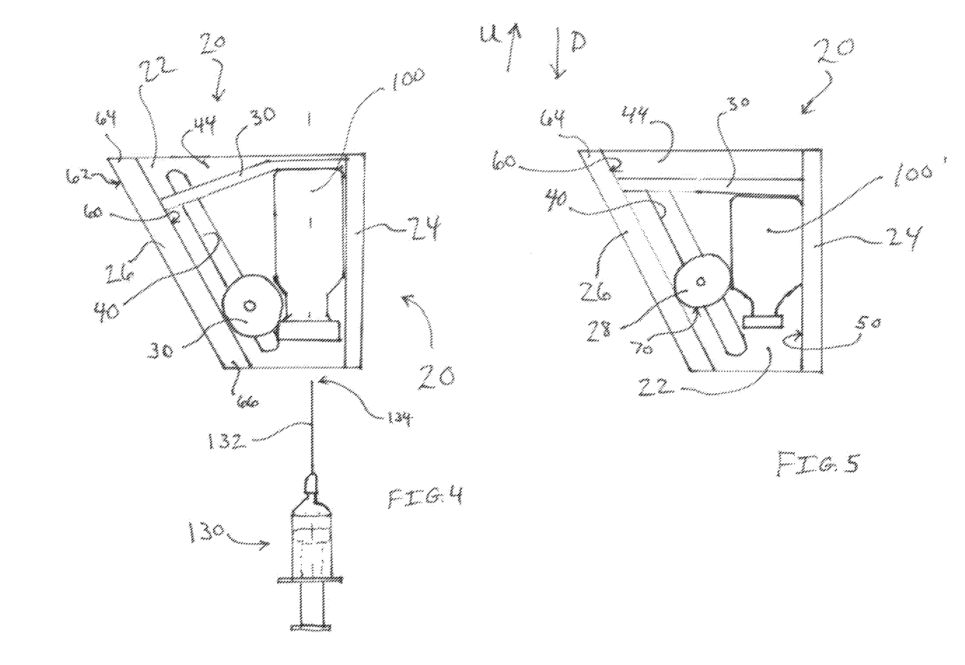

As best seen in FIG. 3, the guide member 28 will guide along the length of the slot 40. The slot 40 is angled relative to the inside surface 50. That is, the direction G is angled relative to the direction D. The guide member 28 is engaged with the slot 40 such that the guide member 40 will move generally in the direction G, as discussed in greater detail below. The

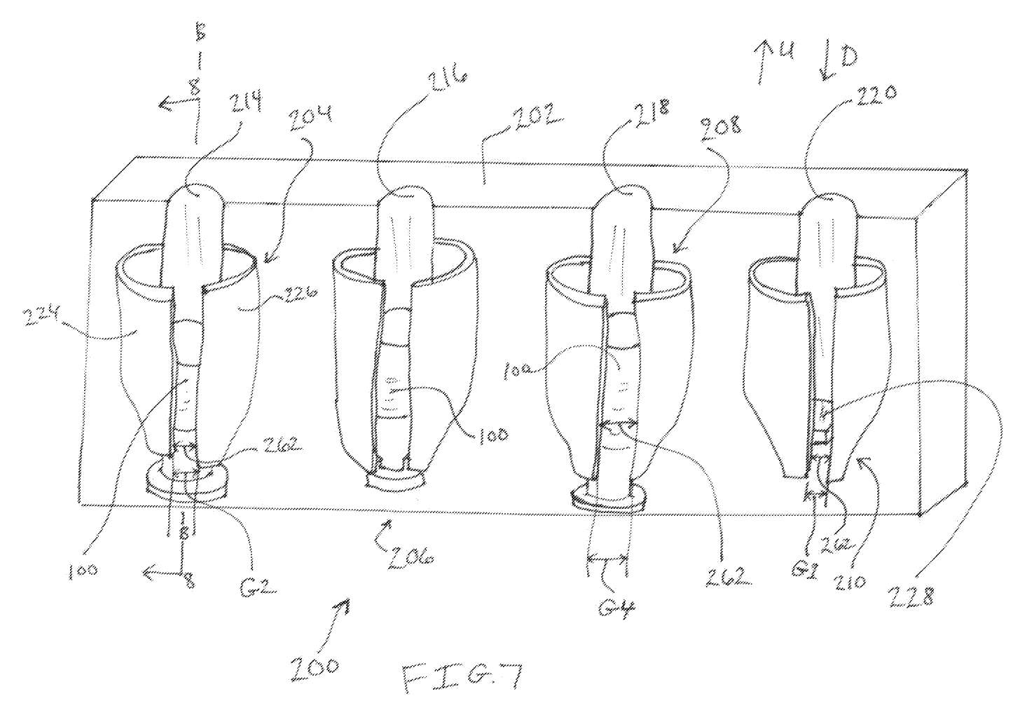

FIG. 6 illustrates an exemplary vial 100. The vial 100 generally defines an axis A-A and includes a generally cylindrical body 102, a bottom 104, a generally frusto-conical shoulder 106, a generally cylindrical neck 108, a generally cylindrical head 110, an inside surface 112, an outside surface 114. A stopper 116 is attached to the vial 100 by crimping a cap 118 to the head 110. The body 102 has a width W1 and a length L1. The neck 108 has a length L2 and a width W2. The head 110 has a length L3 and a width W3. The vial 100 has a length L4. The cap 118 includes an aperture 120 and the head 110 includes an opening 122.

In the embodiment illustrated, the vial 100 is glass, the stopper 116 is a rubber membrane, and the cap 118 is metal, although other materials may be used, as desired. Further, the guide member 28 outer surface 72 is rubber or other suitable material that will grip the vial 100 outer surface 114. Also in the embodiment illustrated, the upper restraint 30 is an elastomeric member, as discussed in greater detail below, although the upper restraint 30 may be any suitable member that resists a vial, such as the vial 100, from movement in the direction U and/or urges the vial to move in the direction D. The body 102 is generally tubular and may be cylindrical or other suitable shape. The vial may have a fluid 128 contained therein where the stopper 116 retains the fluid 128 within the vial 100.

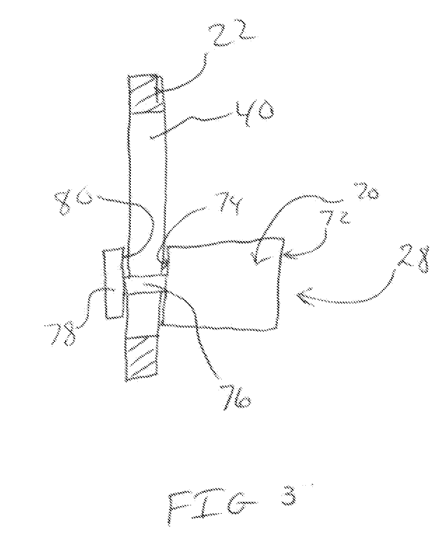

Referring back to FIG. 4, the vial 100 is positioned in the vial holder 20 generally as illustrated. The upper restraint 30 contacts the bottom 104 of the vial 100 to urge the vial 100 to move in the direction D. As the vial 100 moves in the direction D, the vial 100 and the guide member 28 bindingly engage to urge the guide member 28 generally in the direction G (FIG. 2). As the guide member moves in the direction G, the guide member 28 will move toward the inside surface 50 of the side plate 24, thus tightening on the vial 100 and preventing the vial 100 form moving further in the direction D. Thus positioned, the vial holder 20 may restrain the vial 100 from moving in the directions U and D while holding the head 110 of the vial 100 in a lower position than the body 102. As best seen in FIGS. 4 and 5, the upper restraint 30 is an urging member for contacting the bottom 104 and providing a linear urging force generally in the direction D on the vial 100.

FIG. 4 also illustrates a hypodermic syringe 130 adjacent the vial 100. The hypodermic syringe 130 includes a hollow body and a hollow needle 132 having a sharpened tip 134 for piercing the stopper 116, as discussed in greater detail below.

In use, a user may urge the tip 134 of the needle 132 to pierce the stopper 116. As the user pierces the stopper 1116 with the needle 132, the upper restraint 30 resists the first force (in excess of the weight of the vial) provided by the user to prevent the vial from moving such that the stopper is not pierced. That is, some movement of the vial 100 in the direction U may result from the first force exerted by the user. Once the tip 134 of the needle 132 is inside the vial 100, the user may draw a portion of the fluid 128 from the vial 100. Then the user may withdraw the needle 132 from the vial 100 by exerting a second force, generally in the direction D. on the needle 132. As the user exerts the second force on the needle 132, the vial may be urged in the direction D. The interaction between the guide member 28 and the vial 100 discussed above will restrict movement of the vial 100 in the direction D, thereby permitting the user to remove the needle 132 from the stopper 116. Further, the guide member 28 may not restrict movement of the vial 100 in the direction U.

in the embodiment illustrated, the vial holder 20 is illustrated in FIG. 4 restraining a vial 100 of larger dimensions that the vial holder 20 illustrated in FIG. 5. The slot 40 permits the guide member 28 to move at an angle relative to the inside surface 52 thereby permitting the vial holder 20 to accommodate a variety of vials with a variety of dimensions. That is, the vial holder 20 is not intended to hold a limited number of sizes of vials, but can be adjusted to hold an infinite number of sizes of vials, such as the illustrative vial 100.

FIG. 7 illustrates another embodiment of a vial holder as a vial holder 200. The vial holder 200 includes a base 202, a first holder portion 204 generally defining an axis B-B, a second holder portion 206, a third holder portion 208, and a fourth holder portion 210. The base 202 includes a first finger groove 214, a second finger groove 216, a third finger groove 218, and a fourth finger groove 220.

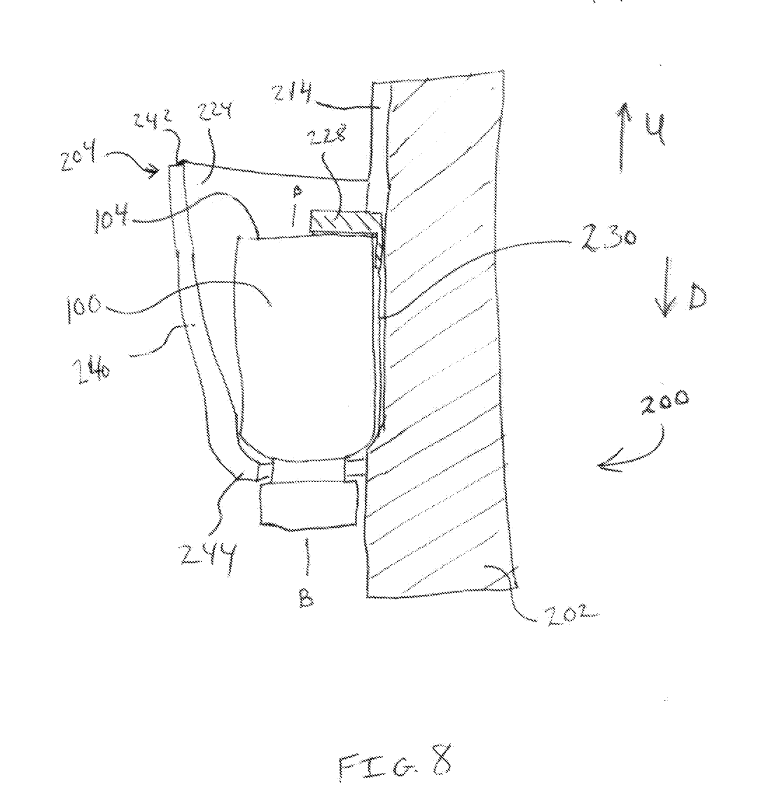

Each of the first holder portions 204, 206, 208, 210 include a first flap 224, a second flap 226, an urging member 228 and a biasing member 230. As best seen in FIG. 8, the first flap 224 includes a generally conical body 240, a first upper lip 242, and a first lower lip 244. The second flap 226 includes a generally conical body 250, a second upper lip 252, and a second lower lip 254. The first lower lip 244 is at least partially defined by a generally circular first lower lip surface 260. The second lower lip 254 is at least partially defined by a generally circular second lower lip surface 260. The first lower lip 244 and the second lower lip 254 are biased inwardly toward the axis B-B generally defining a gap 262 of distance G1, illustrated on the fourth holder portion 210 in FIG. 7. When a vial, such as the vial 100 is interposed within a vial holder portion, such as the first holder portion 204, the gap 262 between the first lower lip 244 and the second lower lip 254 is a distance G2. As illustrated, the distance G2 is larger than the distance G1 since the first holder portion 204 is deflected outward as the vial 100 is interposed therein in an interference fit. That is, the first flap 224 and the second flap 226 are constructed of a resilient material that will deflect away from the axis B-B as a vial is inserted therein, thereby restraining the vial in a desired position.

The urging member 228 contacts the bottom 104 of the vial 100 and extends partially within the finger groove 214 where the urging member 228 is coupled to the biasing member 230. The urging member 228 is moveable in the directions U and D and the biasing member 230 biases the urging member 228 in the direction D. The biasing member 230 may be an elastomeric material or a spring or other suitable member for supplying a biasing force in the direction D.

In the embodiment illustrated, the flaps 224, 226 are constructed of a resilient rubber, although other suitable materials may be used. The first lower lip 244 and the second lower lip 254 at least partially encircle the neck 108 of the vial 100 for retaining the vial 100 within the vial holder 200. Further, the first lower lip 244 and the second lower lip 254 apply a resistive force generally in the direction U against the shoulder 106 to restrain the vial 100 from moving in the direction D.

To position a vial 100 within the vial holder 200, a user may move the urging member 228 in the direction U and interpose the vial 100 between the flaps 224, 226 by deflecting the flaps 224, 226 sufficiently to permit the vial 100 to be inserted therebetween. The user may then position the vial 100 generally as shown in FIGS. 7 and 8 and then release the urging member 228 to permit the urging member 228 to contact the bottom 104 of the vial 100. As best seen in FIG. 7, an infinite number of sizes of vials may be positioned within the holder portions 204, 206, 208, 210.

When removing fluid from a vial 100 that is positioned within a vial holder 200, the user may pierce the stopper 116 with a needle tip 134 by exerting a first force on the needle tip 234 generally in the direction U. As the user moves the needle 132 in the direction U, at least a portion of the first force may he resisted by the urging member 228. Further, at least a portion of the first force may be resisted by the flaps 224, 226.

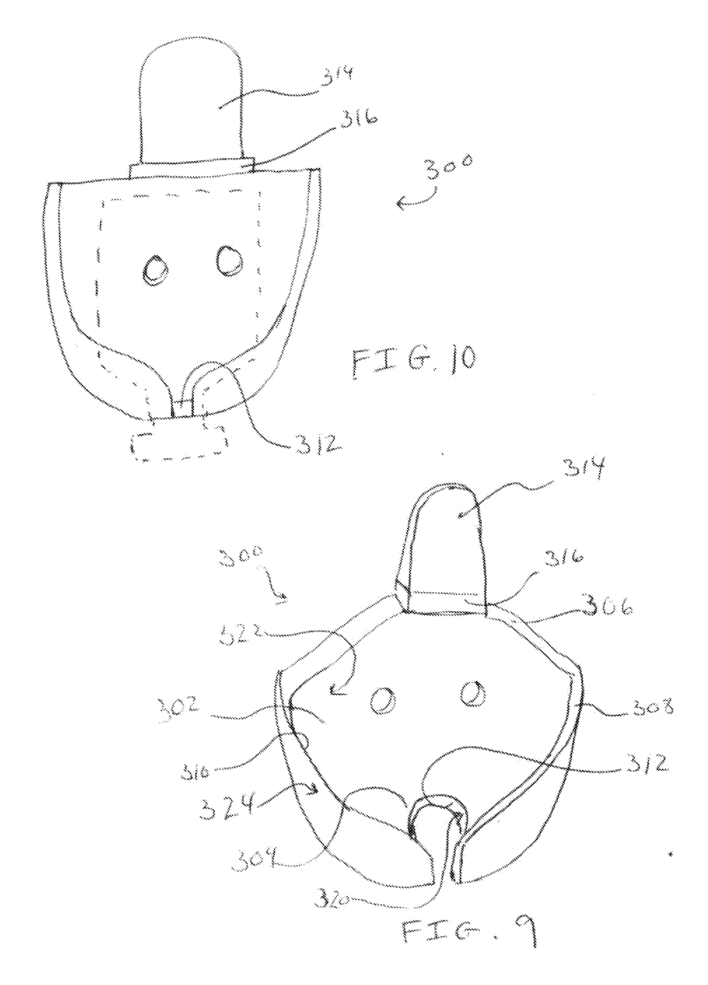

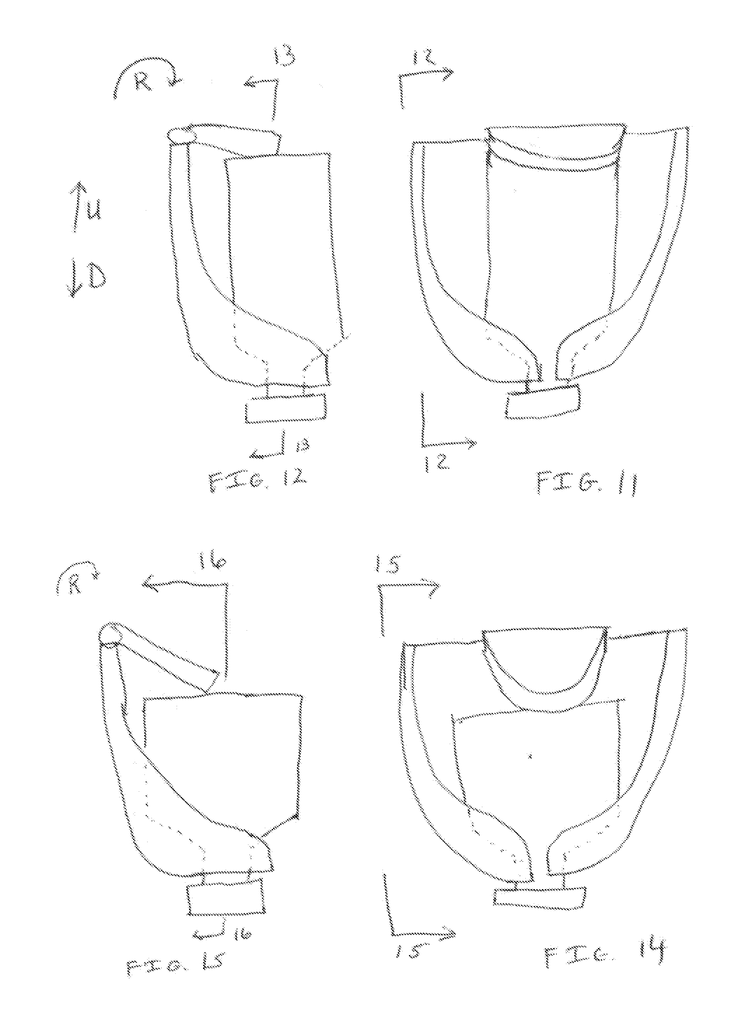

FIGS. 9-16 illustrate another embodiment of a vial holder as a vial holder 300. The vial holder 300 includes a conical body 302 having a lower lip 304, an upper edge 306, a first side edge surface 308, and a second side edge surface 310. The lower lip 304 is defined by a shoulder aperture 312. The upper edge 306 is connected to an urging member 314. The urging member 314 includes a biasing member 316. In the embodiment illustrated, the shoulder aperture 312 is generally circular and defined by a shoulder surface 320 that intersects the first side edge surface 308 and the second side edge surface 310. The body 302 also includes an inside surface 322 and an outside surface 324.

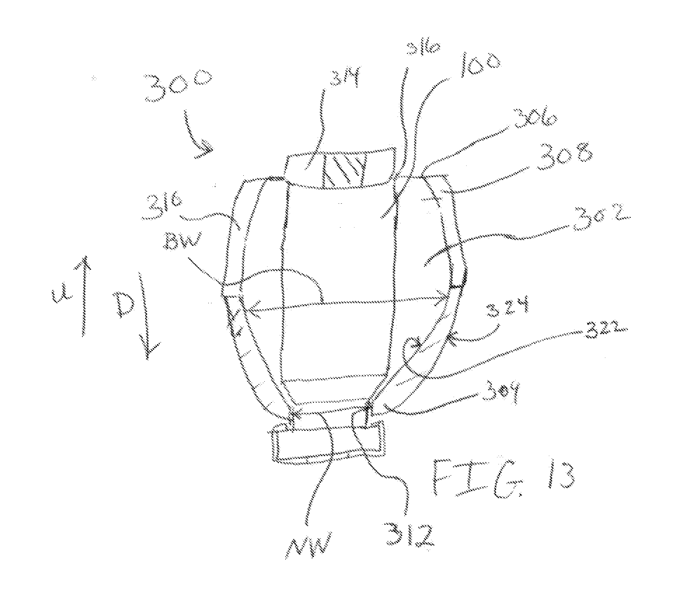

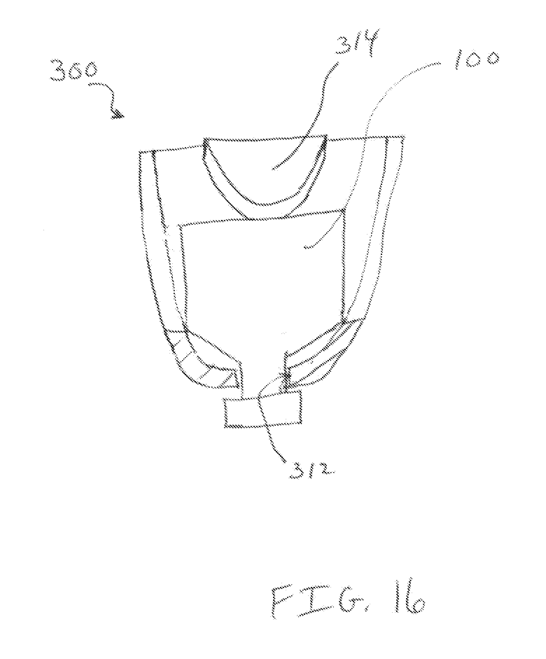

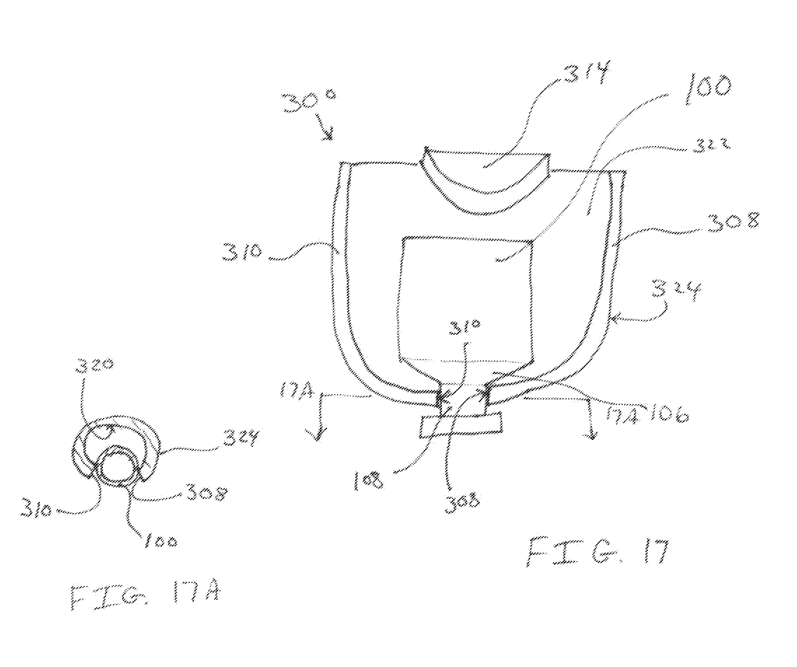

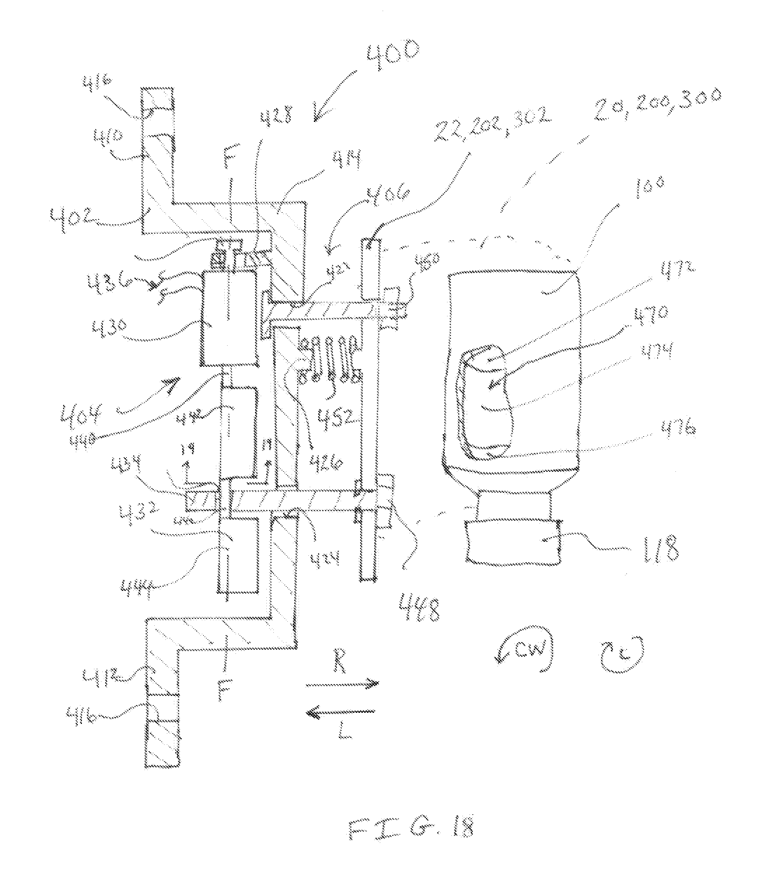

FIG. 13 illustrates that the body 302 has a neck width of a distance NW and a body width of distance BW that increases as measured from an increasing distance from the lower lip 304. That is, at least a portion of the body 302 is conical. As best seen in FIGS. 13 and 16, the body 302 is conical so as to retain a plurality of diameters of vials therein. Specifically, FIG. 13 illustrates the vial holder 300 with a vial 100 having a body diameter W1 that is less than the body diameter of the vial interposed within the vial holder 300 of FIG. 16. As best seen in FIGS. 12 and 15, the biasing member 316 urges the urging member 314 to rotate in the rotational direction R, thereby urging a vial, such as the exemplary vial 100, in the direction D.

As also illustrated in FIGS. 10-16, the neck 108 of the vial 100 may be retained within the shoulder aperture 312 such that the shoulder surface 320 partially encircles the neck 108 in an interference fit. The construction of the vial holder 300 may be such that both the lower lip 304 and the biasing member 316 may resist a force exerted by a user when a needle is pierced through the stopper 116. That is, when a force is exerted generally in the direction U as a needle tip 134 is interposed through the stopper 116.

In the embodiment illustrated, the urging member 314 will resist at least a portion of the first force exerted in the direction U when a user urges a needle to pierce the stopper 116. Further, the lower lip 304 may resist at least a portion of the first force exerted by the user when the needle is pierced through the stopper 116.

To position a vial 100 within the vial holder 300, a user may rotate the urging member 314 in a direction opposite the rotational direction R and position the vial 100 within the vial holder 300 such that the neck 108 or the vial 100 contacts both the first side edge surface 308 and the second side edge surface 310 adjacent the shoulder surface 320. The user may then urge the vial 100 such that the neck 104 will urge the first side edge surface 308 and the second side edge surface 310 to diverge while the neck 104 of the vial 100 moves into the position as seen in FIG. 17. The user may then release the urging member 314 to permit the urging member 314 to contact the bottom 104 of the vial 100.

In the embodiment illustrated, a comparison between FIG. 13 and FIG. 16 demonstrates that vials of varying dimensions may be positioned within the vial holder 300. Indeed, an infinite number of sizes of vials may be positioned within the vial holder 300.

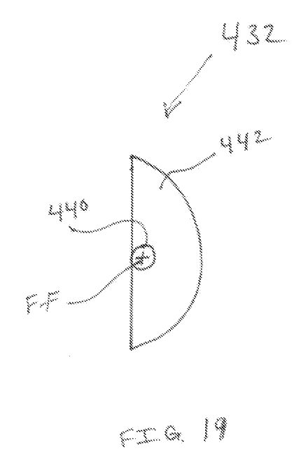

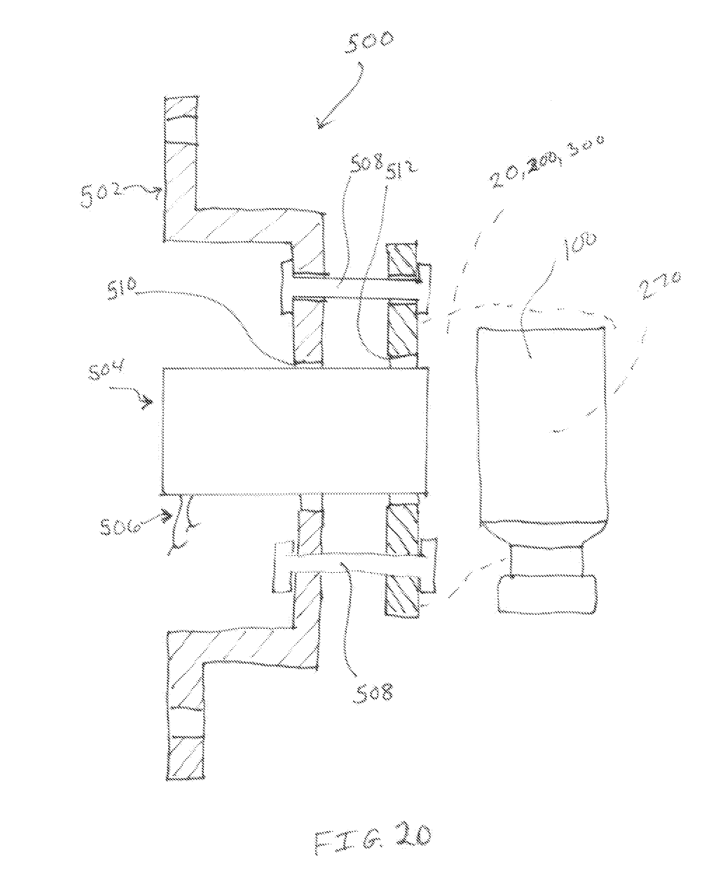

FIGS. 18-20 illustrate an optional feature of the vial holders presented herein. FIG. 18 illustrates an agitator 400. In the embodiment illustrated, the agitator 400 includes a base 402, an agitator portion 404, and a connection portion 406. The base 402 includes a first mounting portion 410, a second mounting portion 412, and a body 414. Each mounting portion 410, 412 includes a mounting aperture 416 for attaching the agitator 400 to a structure. such as a wall. The body 414 includes a generally vertical portion 420 having a first aperture 422 a second aperture 424, a raised portion 426, and a motor mount 428. The agitator portion 404 includes an electric motor 430, an off-center weight 432, and a connector rod 434. The motor 430 includes input wiring 436 and a mounting peg 438. The weight 434, as seen in FIGS. 18 and 19, includes a shaft 440 generally defining an axis F-F rotatably connected to the motor 430, a first weight 442, and a second weight 444. The connector rod 434 includes an aperture 446 formed therein with the shaft 440 interposed therethrough. The connector rod 440 also includes a first connector portion 448 for connecting to a vial holder, such as the vial holder 22, 200, or 300 (illustrated partially in phantom). The connection portion 406 includes a connecting fastener 450 and a spring 452.

In operation, electrical energy (either AC or DC) is supplied to the motor 430 via the input wiring 436 causing the motor 430 to rotate the off-center weight 434. Rotation of the off-center weight 432 will cause the off-center weight 432 and the motor 430 to oscillate as the off-center weight 432 and the motor 430 are urged at least in the direction R and then in the direction L in one cycle of oscillation. As the motor 430 rotates the off-center weight 432 at about 3600 rotations per minute (rpm), the vial 100 will oscillate in the rotational directions C and CW. That is, as the motor 430 causes the off-center weight 432 to rotate, the imbalance of the first weight 442 and the second weight 444 relative to the axis F-F (as best seen in FIG. 19) will urge the shaft 440 to move perpendicular to the direction of the axis F-F. Since the shaft 440 is rotatably connected to the connector rod 434, this movement of the shaft 440 will cause the connector rod 434 to oscillate in the directions R and L. The spring 452 partially dampens these oscillations since the spring is positioned between the connecting fastener 450 and the connector rod 434. Therefore, the agitator portion 404 mixes at least a portion of the contents of the exemplary vial 100.

In the embodiment illustrated, the agitator 400 will provide a generally horizontal oscillatory motion to a lower portion of a vial to agitate the contents of the vial, although other types of motion, such as vertical oscillatory motion, may be used.

FIG. 20 illustrates an ultrasonic generator, or agitator, 500 used as an agitator to mix the contents of the vial holders 20, 200, 300 disclosed herein. The agitator 500 includes a base 502, an ultrasonic generator 504, input wiring 506, and connecting fasteners 508. The base 502 includes a base aperture 510 to permit the ultrasonic generator 504 to extend therethrough. In the embodiment illustrated, the vial holder 20, 200, 300 includes a holder aperture 512, although a vial aperture may not be used, as desired. The ultrasonic generator 504 is similar to ultrasonic generators disclosed in U.S. Pat. No. 3,975,650; U.S. Pat. No. 2,821,956; U.S. Pat. No. 5276376; and U.S. Pat. No. 4,868,445, the disclosures of which are hereby incorporated by reference in their entireties.

In operation, ultrasonic energy is directed from the generator 504 toward the vial 100 and vial holder to agitate the contents 270 of the vial 100. Specifically, this ultrasonic energy is transmitted through the body 102 of the vial 100 to agitate the vial 100 which mixes the contents 270 to obtain a more homogeneous suspension. That is, mixing at least a portion of the contents 270 of the vial 100 includes exciting vibrations in the contents 270 of the vial 100 through the body 102 of the vial 100 with the ultrasonic generator 504.

Some vials include solutions having particles suspended in fluids and/or fluids of differing densities that may separate. Exemplary fluids include drugs such as Depo-medrol which are desirably shaken to mix the contents of the vial prior to removal of at least a port of the contents with a syringe, such as the syringe 130. The vial 100 illustrated in FIG. 18 contains contents 470 that include a gas 472, a liquid 474 and a particulate (or liquid with a higher density than the liquid 474) 476. In the embodiment illustrated, the contents 470 have settled such that the particulate 476 is located at a lower portion of the vial 100 than the liquid 474. Prior to withdrawing a portion of the contents, the user may desire to mix the contents 470 to obtain a more homogeneous suspension. The agitators 400, 500 permit a user to agitate a solution within a vial to obtain a homogeneous suspension with respect to the fluid and particulates of the suspension.

Although the steps of the method of using the vial holders may be listed in an order, the steps may he performed in differing orders or combined such that one manipulation may perform multiple steps. Furthermore, a step or steps may be initiated before another step or steps are completed, or a step or steps may be initiated and completed after initiation and before completion of (during the performance of) other steps.

The preceding description has been presented only to illustrate and describe exemplary embodiments of the methods and systems of the present invention. It is not intended to be exhaustive or to limit the invention to any precise form disclosed. It will he understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

What is claimed is:

1. A vial holder for a vial, wherein the vial includes a body portion having a generally tubular portion interposed between a bottom and a shoulder portion, the vial further including a neck portion, wherein the neck portion interconnects the shoulder portion to a head portion, a cap portion is connected to the head portion, and wherein the cap portion includes a membrane for retaining a fluid within the vial, the vial holder comprising:
a restraining portion for, at least in part, restraining the vial from moving in a first direction;
an urging member for resisting a force exerted in a second direction on the vial when a needle is urged to pierce the membrane; and
wherein the first direction is generally opposite the second direction.

2. The apparatus of claim 1, wherein the restraining portion will restrain the vial from movement in the second direction.

3. The apparatus of claim 1, wherein the restraining portion at least partially encircles the neck portion of the vial.

4. The apparatus of claim 1, wherein the restraining portion exerts a first biasing force on the vial in the first direction and a second biasing force on the vial in a third direction, where the third direction is generally perpendicular to the first direction.

5. The apparatus of claim 4. wherein the restraining portion contacts a portion of the tubular body portion of the vial.

6. The apparatus of claim 1, further comprising a biasing member for urging at least a portion of the urging member to move in the first direction.

7. The apparatus of claim 6, wherein the biasing member exerts a linear urging force on the urging member.

8. The apparatus of claim 6, wherein the urging member selectively contacts the bottom of the vial.

9. The apparatus of claim 8, wherein the vial holder selectively retains a first vial having a first height, measured from the bottom to the neck.

10. The apparatus of claim 1, further comprising an agitator for selectively mixing the contents of the vial.

11. A method of retaining a vial within a vial holder, wherein the vial includes a body portion having a generally tubular portion interposed between a bottom and a neck portion, wherein the neck portion interconnects the body portion to a head portion, a cap portion is connected to the head portion, and wherein the cap portion includes a membrane, the method comprising:
positioning the neck portion of the vial at least partially within a first restraining portion of the vial holder;
positioning an urging portion of the vial holder in contact with the bottom of the vial;
piercing the membrane with a needle with a first force directed generally in a first direction; and
resisting at least a portion of the first force with the urging portion.

12. The method of claim 11, wherein only a portion of the first force is resisted by the urging portion.

13. The method of claim 11, further comprising gripping the outer surface of the tubular portion with a gripping portion of the vial holder to axially restrain the vial relative to the vial holder.

14. The method of claim 11, further comprising positioning the shoulder of the vial in contact with the vial holder.

15. The method of claim 11, further comprising resisting at least a portion of the first force with the first restraining portion.

16. The method of claim 11, further comprising mixing at least a portion of the contents of the vial with an agitator.

17. The method of claim 16, wherein mixing at least a portion of the contents of the vial includes exciting vibrations in the contents of the vial through the body portion of the vial with an ultrasonic generator.

18. A method of retaining a vial within a vial holder, wherein the vial includes a body portion having a generally tubular portion interposed between a bottom and a neck portion, wherein the neck portion interconnects the body portion to a head portion, a cap portion is connected to the head portion, and wherein the cap portion includes a membrane, the method comprising:
positioning the body portion of the vial at least partially within a first restraining portion of the vial holder;
positioning an urging portion of the vial holder in contact with the bottom of the vial;
piercing the membrane with a needle with a first force directed generally in a first direction; and
resisting at least a portion of the first force with the urging portion

19. The method of claim 18, further comprising mixing at least a portion of the contents of the vial with an agitator.

20. The method of claim 19, wherein the agitator includes an ultrasonic generator that excites vibrations in the contents of the vial through the body portion of the vial.
